(19) United States
(12) Patent Application Publication
(10) Pub. No.: US 2022/0341132 A1
(43) Pub. Date: Oct. 27, 2022

(54) MONITORING GROUND-ENGAGING TOOL, SYSTEM, AND METHODS FOR EARTH WORKING EQUIPMENT AND OPERATIONS

(71) Applicant: ESCO Group LLC, Portland, OR (US)

(72) Inventors: Christopher M. Carpenter, Tualatin, OR (US); Rodney K. Clarke, Cleveland (AU); Xudan Xu Morris, Banks, OR (US)

(73) Assignee: ESCO Group LLC, Portland, OR (US)

(21) Appl. No.: 17/639,894

(22) PCT Filed: Aug. 28, 2020
(86) PCT No.: PCT/US2020/048634

§ 371 Date: Mar. 2, 2022

Related U.S. Application Data
(60) Provisional application No. 62/894,635, filed on Aug. 30, 2019.

(51) Int. Cl. E02F 9/26

(52) U.S. Cl. CPC E02F 9/267

(57) ABSTRACT

A system and tool for monitoring earth working equipment for such things as part identification, cracks, deformation, presence, operational limits, equipment faults, equipment proximity violations, locate system sensors, condition, usage, and/or performance of the products on earth working equipment used, for example, in mining, construction, and/or dredging environments.

### RELATED APPLICATIONS

This application is based upon International Application No. PCT/US2020/048634, filed Aug. 28, 2020, which claims priority benefits to U.S. Provisional Patent Application No. 62/894,635 filed Aug. 30, 2019 both entitled “MONITORING GROUND-ENGAGING TOOL, SYSTEM, AND METHODS FOR EARTH WORKING EQUIPMENT AND OPERATIONS,” which is incorporated herein by reference in its entirety.

### FIELD OF THE INVENTION

The present disclosure pertains to a tool, system, and/or method for monitoring earth working equipment and/or operations.

### BACKGROUND OF THE INVENTION

In various kinds of earth working activities, ground-engaging products (e.g., teeth) are commonly provided on earth working equipment to protect the underlying equipment from undue wear and, in some cases, perform other functions such as breaking up the ground or earthly material.

During use, such ground-engaging products can encounter heavy loading and highly abrasive conditions. These conditions can cause the products to wear or become separated from the earth working equipment. For example, as a bucket engages the ground, a point or adapter may become separated from the digging edge. The operators of the earth working equipment may not always be able to see when such products have separated from the bucket. Continuing to operate the earth working equipment with missing ground-engaging products can lead to a decrease in production, excessive wear on other components on the earth working equipment and/or damage to downstream equipment.

The abrasive environment associated with digging and other earth working activities can also cause the ground-engaging products to become worn out. Excessive wearing can result in breakage and/or loss of the products during use, as well as, decreased equipment efficiency and production, greater costs in fuel consumption, etc.

### SUMMARY OF THE INVENTION

The present disclosure pertains to a tool, system and/or method for monitoring earth working equipment and/or operations such as used in mining, construction, and/or dredging.

In one embodiment, a monitoring system and/or method includes an earth working equipment and a monitoring tool. The monitoring tool has a mobile device movable to different remote positions relative to the earth working equipment, and a sensor on the mobile device to detect a crack on at least one monitored portion of the earth working equipment.

In another embodiment, a monitoring system and/or method includes an earth working equipment and a monitoring tool. The monitoring tool has a mobile device movable to different remote positions relative to the earth working equipment, and a sensor on the mobile device to detect a deformation of at least one monitored portion of the earth working equipment.

In another embodiment, a monitoring system and/or method includes an earth working equipment and a monitoring tool. The earth working equipment has a ground-engaging product with a front end, a rear end, an upper side and an underside. The monitoring tool has a mobile device movable to different remote positions relative to the earth working equipment, and a sensor on the mobile device to remotely detect a characteristic of at least the underside of the ground-engaging product.

In another embodiment, a monitoring system and/or method includes an earth working equipment and a monitoring tool. The monitoring tool has a mobile device movable to different remote positions relative to the earth working equipment, a sensor on the mobile device to detect a characteristic of at least one monitored portion of the earth working equipment, and a controller with one or more non-transitory computer readable storage media, a communication system, a processing system operatively coupled with the one or more computer readable storage media, and program instructions stored on the one or more computer readable storage media and executed by the processing system. The program instructions include receiving a location of at least one beacon carried by a person and/or a machine beacon and determining a path for the mobile device that avoids the at least one beacon in order to monitor at least one monitored portion of the earth working equipment.

In another embodiment, a monitoring system and/or method includes an earth working equipment and a monitoring tool. The monitoring tool has a mobile device movable to different remote positions relative to the earth working equipment, at least one sensor on the mobile device to detect a characteristic of at least one monitored portion of the earth working equipment and/or any person located near the mobile device, and a controller using programmable logic that receives data from the sensor to determine a location of the earth working equipment and/or each person, and to direct the mobile device along a path that avoids the earth working equipment and/or each person when monitoring the at least one monitored portion of the earth working equipment.

In another embodiment, a monitoring system, tool and/or method includes a mobile device and a sensor on the mobile device for detecting a characteristic of at least a monitored portion of an earth working equipment. The mobile device includes an unmanned aerial vehicle (UAV). The UAV may follow a flight path from an originating location (e.g., a service vehicle, fixed location, etc.) to the earth working equipment. The UAV may have a partially pre-programmed flight path until it can pick up a beacon (or other signal) and/or a visual recognition of the equipment. At this point, a processor can be used to move the UAV to the equipment. The sensor may optionally detect via sensors on the equipment, visual recognition, etc. the position and orientation of the equipment, boom, stick, bucket and/or wear parts to conduct the desired monitoring. GPS could optionally, additionally or in lieu of these other systems, be used to follow the flight plan. An obstacle avoidance system is preferably provided so the drone can avoid natural obstacles (e.g., mountains, trees, etc.), manmade obstacles (e.g., other equipment) and/or people.

In another embodiment, a monitoring system, tool and/or method can detect the presence of people near the wear part and/or earth working equipment to be monitored to avoid harming anyone. As examples, the monitoring tool may detect tokens worn by the workers (e.g., beacons), optical recognition software, etc. The monitoring tool could stay a prescribed distance from the detected people and/or include obstacle avoidance software. Similarly, other equipment, tools, etc. could be detected by the monitoring device to avoid contact with them as well.

In another embodiment, a monitoring system, tool and/or method includes a mobile device with a sensor to detect the location and/or orientation of the earth working equipment and/or associated ground-engaging products (such as a bucket and/or teeth). In this way, the sensor can be positioned to monitor the desired portion(s) of the equipment and/or wear part(s).

In another embodiment, a monitoring system, tool and/or method includes a mobile device with a sensor to detect the movements of an earth working equipment during operation and a controller using programmable logic to control the movements of the mobile device. The system, tool and/or method includes gathering information about the path, orientation, and/or position of the earth working equipment and optionally transport vehicle(s) and/or other equipment so that a real-time safe zone can be determined in which the mobile device can move. The controller moves the mobile device in the safe zone for the sensor to monitor at least one monitored portion of the earth working equipment.

In another embodiment, a monitoring system and/or method includes an inventory container at a worksite and a monitoring tool. The inventory container has one or more ground-engaging product for earth working equipment at the worksite. The monitoring tool has a mobile device movable to different remote positions relative to the inventory container, and a sensor on the mobile device to detect a part identification of each said ground-engaging product in in the inventory container in order to monitor inventory usage at the worksite.

In another embodiment, a monitoring tool includes a mobile device movable to different remote positions relative to an earth working equipment, and a sensor on the mobile device to detect a crack on at least one monitored portion of the earth working equipment.

In another embodiment, a monitoring tool includes a mobile device movable to different remote positions relative to an earth working equipment, and a sensor on the mobile device to detect a deformation of at least one monitored portion of the earth working equipment.

In another embodiment, a monitoring tool includes a mobile device, at least one sensor and a controller. The mobile device is movable to different remote positions relative to the earth working equipment. The at least one sensor is on the mobile device to detect a characteristic of at least one monitored portion of the earth working equipment and any person located near the mobile device. The controller uses programmable logic to receive data from the sensor to determine a location of the earth working equipment and/or each person, and to direct the mobile device along a path that avoids the earth working equipment and/or each person when monitoring the at least one monitored portion of the earth working equipment.

In another embodiment, a human obstacle avoidance computing system includes one or more computer readable storage media, a processing system operatively coupled with the one or more computer readable storage media, and program instructions stored on the one or more computer readable storage media and executed by the processing system. The program instructions include receiving the location of at least one beacon carried by a person and determining a path for a monitoring device that avoids the at least one beacon in order to monitor at least one monitored portion of an earth working equipment.

The various above-noted implementations and examples are usable together or independently. To gain an improved understanding of the advantages and features of the disclosure, reference may be made to the following descriptive matter and accompanying figures that describe and illustrate various configurations and concepts related to the disclosure.

### BRIEF DESCRIPTION OF THE DRAWINGS

FIG. 1 is a side view of a first example of an earth working machine.

FIG. 2 is a perspective view of a lip of a bucket with tooth assemblies and shrouds.

FIG. 3 is a perspective view of one of the tooth assemblies shown in FIG. 2.

FIG. 4 is a bottom perspective view of the tooth assembly shown in FIG. 3.

FIG. 5 is an exploded perspective view of the tooth assembly shown in FIG. 3.

FIG. 6 is an exploded view of an underside or bottom of the tooth assembly shown in FIG. 5.

FIG. 7 illustrates a first example of a system and its use in accordance with the present disclosure, e.g., where system includes a tool that is an airborne device used to monitor products on earth working equipment.

FIG. 8 illustrates a three-dimensional (3D) representation of a bucket and a lip indicating a crack and a deformation.

FIG. 9 is a front view of a mobile handheld device with a human machine interface (HMI) to be used with a monitoring system in accordance with the present disclosure.

FIG. 10 illustrates a second example of a tool and its use, e.g. where the tool is mounted on a vehicle and is used to monitor products on earth working equipment.

FIG. 11 illustrates a process according to the present disclosure.

FIG. 12 illustrates a second example of a system and its use in accordance with the present disclosure, e.g., where a tool is an airborne device used to monitor a bottom portion of a ground-engaging product and display the results on a monitor or display on an earth working machine.

FIG. 13 illustrates a second process according to the present disclosure.

FIG. 14 illustrates a system in another alternative use in accordance with the present disclosure, e.g., where an airborne tool is used to monitor a loading condition of, e.g., a hopper for a crusher or the truck tray for a haul trunk such as used in mining operations.

FIG. 15 is a schematic system diagram illustrating a system in accordance with the present disclosure.

### DETAILED DESCRIPTION OF THE INVENTION

The present disclosure pertains to a tool, system, and/or method for monitoring characteristics of ground-engaging products, earth working equipment (e.g., excavating machines, conveyer equipment, and mineral processing equipment), and/or earth working operations.

In one example, the monitoring tool, system, and/or method for monitoring earth working equipment, operations and/or associated products includes a mobile device with at least one sensor. The monitoring tool, system and/or method can include all the features, capabilities, embodiments and/or operations as disclosed for the monitoring tool, system and/or method in U.S. Patent Application Publication No. 2016/0237640 and PCT Patent Application No. PCT/US2020/032617 filed May 13, 2020, which are both herein incorporated by reference in their entireties.

The sensor of the monitoring tool can detect one or more characteristic of the equipment and/or product(s) and/or its operation(s). The characteristics can, for example, include information regarding part and/or equipment identification, location, motion, operational limits, equipment faults, equipment proximity violations, locate system sensors, presence, usage, condition, wear, cracking, deformation, and/or performance of one or more product and/or equipment and/or its operations. The earth working equipment can be, for example, excavating equipment, conveyer equipment, and/or mineral processing equipment.

Information and/or components relating to part and/or equipment identification may, e.g., include such things as bar codes, QR codes, part and/or equipment numbers, part and/or equipment tags, part and/or equipment beacons, inventory tub identification, RFIDs, transmitters, and/or other means of identification that the tool may be able to gather and/or monitor. Such monitoring could take place during use of the various equipment, from equipment inventory depositories (e.g. warehouses, inventory yards, or tubs), mining sites, mineral processing sites, etc.

Information and/or components related to operational limits may, e.g., include such things as over fill of equipment and/or overstressing equipment. Information and/or components related to equipment faults may include, e.g., such things as predetermined values set for maximum wear (e.g. wear profiles for top, sides, and/or bottom wear), crack characteristics (e.g. length, depth, width, etc.), deformation (e.g. angle α, severity, etc.), component position, performance, etc.

Information and/or components related to equipment proximity violations may, e.g., include such things as a predetermined radius of safety for proximity to earth working equipment by the monitoring tool, human proximity to earth working equipment, human proximity to the tool, earth working equipment to other earth working equipment, and/or earth working equipment to the tool, safety radius violations, etc.

Information and/or components related to locating system sensors may, e.g., include such things as beacons, wear sensors, blast monitoring sensors, road condition sensors, material monitoring sensors, flow monitoring sensors, fill sensors, human proximity devices, location sensors, etc.

Information and/or components related to part identification may, e.g., include such things as product type, product number, serial number, customer number, brand name, trademark, bill of material, maintenance instructions, use instructions, etc.

Information and/or components related to usage may, e.g., include such things as the type of earth working equipment to which the ground-engaging product is secured, number of digging cycles, average time of digging cycles, duty cycle, location of the product on the equipment, product strain, resisted loads, impacts, etc.

Information and/or components related to the condition of the earth working equipment and/or ground-engaging products may, e.g., include such things as wear, damage, cracks, deformation, etc.

Information and/or components related to performance may, e.g., include such things as the rate of digging, tons moved per increment of wear, fill rates, throughput for the earth working equipment, etc. For example, how much material is loaded in a bucket over a period time, how much material is loaded into a haul truck body over time (which includes measuring the loss of material in transfer), how material is passed through a crusher over a period of time, how much material is passed through a chute or onto a conveyer over time, etc.

Information and/or components related to environment may include such things as weather (e.g. temperature), dew point, dig face condition, blast boundary condition, blast fragmentation, barometric pressure, humidity, wind velocity, heat index, wind chill, visibility, smoke, etc.

These characteristics could be determined using data generated by the monitoring tool alone or in combination with other information from, e.g., sensors in ground-engaging products and/or earth working equipment, databases and/or other remote devices (i.e., remote from the tool). As examples, additional information may include mine geology, fragmentation information, machines in use, fuel consumption, loads applied, strain, impacts, duration of service, past history, etc. The system can be used to determine such things as location and timetables for excavating certain material, replacement schedules for products, etc. Tools can also be used to detect product loss (e.g., presence). These monitored characteristics are given as examples only and are not intended to be limiting.

Earth working equipment may, e.g., include such things as excavating equipment, ground conveying equipment, and/or mineral processing. Excavating equipment is intended as a general term to refer to any of a variety of excavating machines used in mining, construction and other activities, and which, for example, include loaders, dragline machines, cable shovels, face shovels, hydraulic excavators, continuous miners, dozers, road headers, shear drums, dredge cutters, etc. Excavating equipment may also refer to ground-engaging capital products secured or securable to excavating machines, which may, e.g., include such things as buckets, blades, drums, cutter heads, etc. Ground conveying equipment is also intended as a general term to refer to a variety of equipment that is used to convey or otherwise transport earthen material and which may include, for example, such things as chutes, trailers, conveyors, material handling machines, feeders, crushers, haul trucks, etc. Ground conveying equipment may also refer to capital products for this equipment including, e.g., truck trays. Mineral processing equipment is also intended as a general term to refer to equipment for processing the excavated material, which can, for example, include crushers, separators, milling machines, cyclones, etc.

Relative terms such as front, rear, top, bottom, and the like are used for convenience of discussion. The terms front or forward are generally used (unless otherwise stated) to indicate the usual direction of travel of the earthen material relative to the product during use (e.g., while digging), and upper or top are generally used as a reference to the surface over which the material passes when, for example, it is gathered into the bucket. Nevertheless, it is recognized that in the operation of various earth working machines, the ground-engaging products may be oriented in various ways and move in all kinds of directions during use.

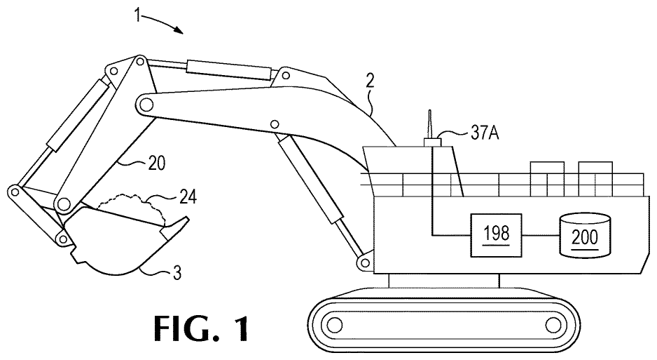

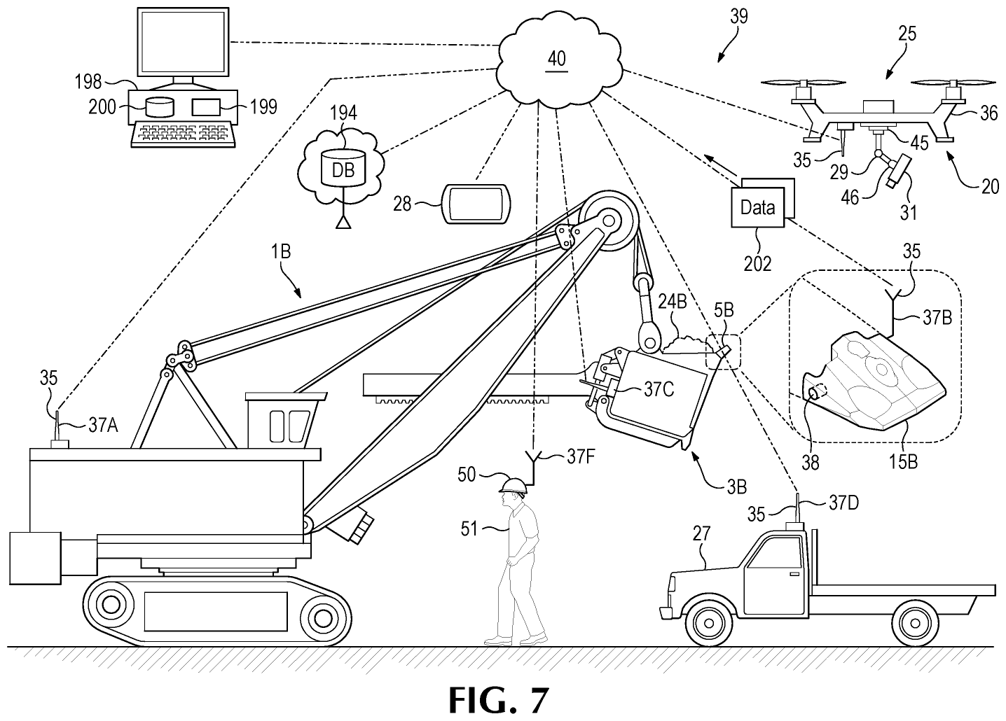

FIG. 1 illustrates an example of an earth working equipment as a mining excavator 1. Excavator 1 is be equipped with a boom 2 having a bucket 3 for gathering earthen material 24 while digging. Other excavating machines and multiple configurations of buckets are known and variations in bucket geometry exist. For example, FIG. 7 illustrates an earth working equipment as a cable shovel 1B. The cable shovel 1B has a bucket 3B with a hinged bottom door to release the gathered material 24B. The monitoring systems, tools and/or methods can be used with other kinds of machines and/or bucket configurations, which can, e.g., include draglines having buckets without top walls, face shovels having buckets wherein the side walls are hinged, etc. The specific machine and/or bucket is not intended to be limiting as the present disclosure can be used with various types of machines, buckets and with various types of wear parts, attachments, and components used on various different kinds of earth working equipment. Moreover, while this disclosure primarily discloses the monitoring systems, tools and/or methods in connection with excavating equipment, these systems, tools and/or methods can also be used to monitor other earth working equipment such as conveying equipment and/or mineral processing equipment.

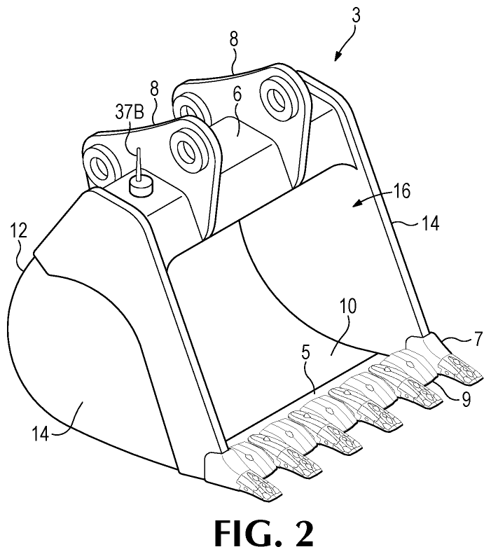

Referring to FIG. 2, the bucket 3 includes a shell 4 defining a cavity 16 for gathering material during the digging operation. Shell 4 includes a rear wall 12 having attachment supports 8 to attach the bucket 3 to earth working equipment 1, and a pair of opposing sidewalls 14 located to each side of rear wall 12. The bucket 3 has a lip 5 that defines a digging edge 34 of the bucket 3. Tooth assemblies 7 and shrouds 9 are secured to the digging edge 34 to protect the edge 34, break up the ground ahead of the lip 5, and gather material into the bucket 3. As one example, the teeth and shrouds may be as disclosed in U.S. Pat. No. 9,222,243, which is incorporated herein by reference in its entirety, but many other kinds may be used.

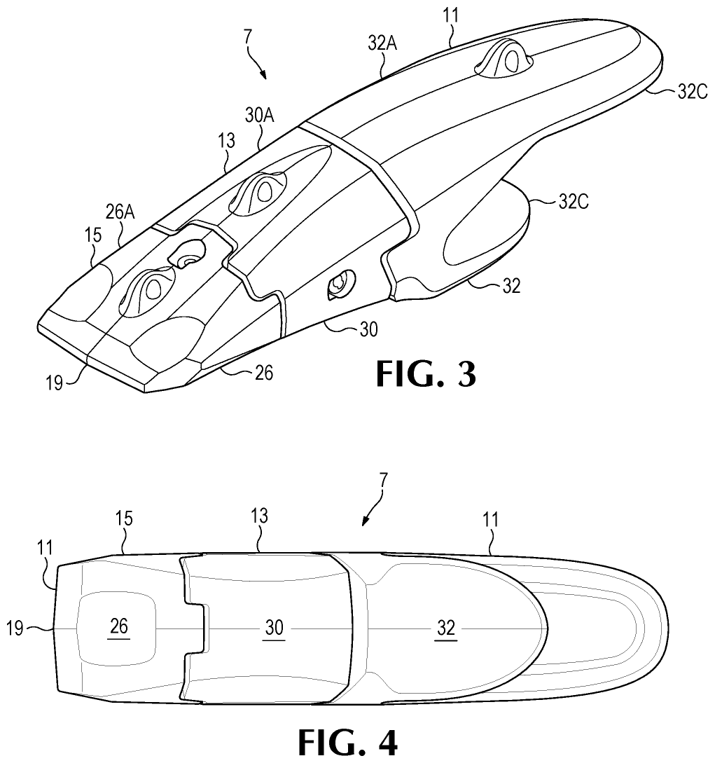

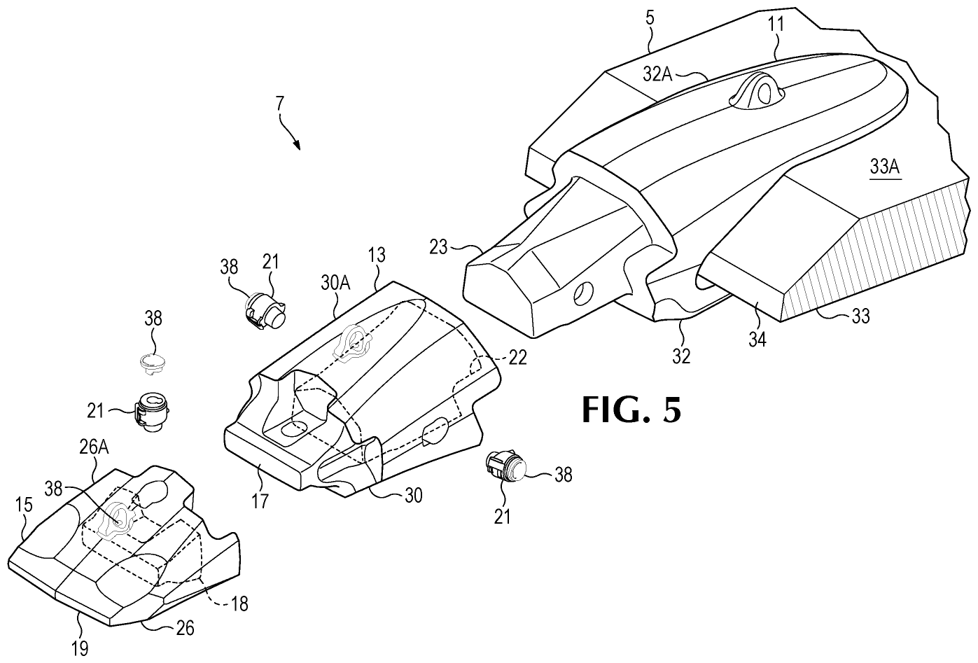

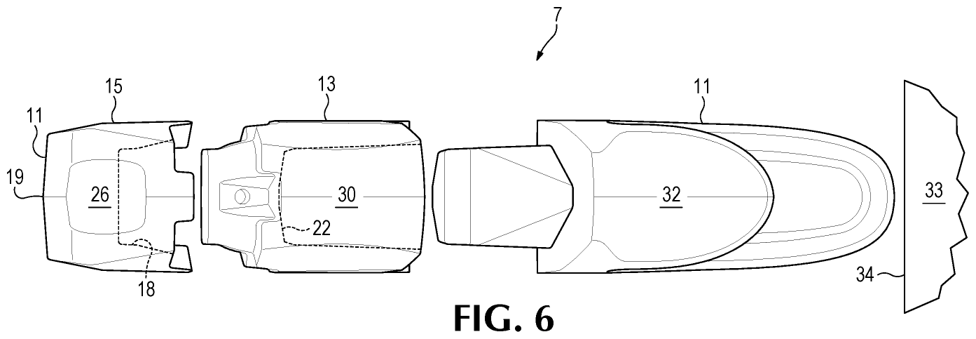

With reference to FIGS. 3-6, each tooth 7 includes an adapter 11 to be welded to lip 5, an intermediate adapter 13 mounted on adapter 11, and a point (also called a tip) 15 mounted on intermediate adapter 13. Point 15 includes a bottom surface 26 and an opposite top surface 26A, a rearwardly-opening cavity 18 to receive nose 17 of intermediate adapter 13, and a front end 19 to penetrate the ground. Intermediate adapter 13 includes a bottom surface 30, an opposite top surface 30A, and a rearwardly-opening cavity 22 to receive the adapter 11. Adapter 11 includes a nose 23, a bottom surface 32, an opposite top surface 32A, and rearwardly extending legs 32C to straddle lip 5. The lip 5 includes a bottom surface 33, an opposite top surface 33A and a front edge 33B. Likewise, the shroud 9 also includes a bottom surface, an opposite top surface, a front edge, and a pair of rearwardly extending legs to straddle the lip 5 (not shown). Locks 21 are used to secure wear member 15 to intermediate adapter 13, and intermediate adapter 13 to adapter 11 (FIG. 6).

In accordance with this example tooth 7, the point 15 will generally wear out and need to be replaced a number of times before the other tooth components. The intermediate adapter 13 may be referred to as a base for wear part 15 or as a wear part itself. Likewise, the adapter 11 may be considered a base for intermediate adapter 13 (or a point) or a wear part. When such a ground-engaging product reaches a minimum recommended wear profile (e.g., the wear member is considered fully worn), the product is replaced so that production does not decrease and/or the base, upon which the product mounts, does not experience unnecessary wear.

For ease of discussion, this disclosure generally discusses one example of monitoring a specific tooth assembly secured to an excavating bucket. However, the tool or system could be used to monitor other products, characteristics, operations, earth working equipment and/or earthen material.

With reference to FIG. 7, a system 39 is illustrated according to one example of the disclosure. The system 39 may, e.g., include an earth working equipment 1B having a ground engaging product 3B, a communication network 40, a monitoring tool 25, a database 194, a transport vehicle 27, a human proximity device 50, a computing system 198, and/or a handheld device 28. The earth working equipment 1B includes a communication device 35, a beacon 37A, and/or other wireless transmitters and/or receivers. The earth working equipment 1B includes a bucket 3B having a lip 5B and carrying a load 24B. The lip 5B has teeth with tips 15B. The tips 15B may include a communication device 35, a beacon 37B, and/or other wireless transmitters and/or receivers. The bucket 3B may also include a communication device 35, a beacon 37C, and/or other wireless transmitters and/or receivers. Workers 51 may also have a beacon 37F.

The earth working equipment 1B, the transport vehicle 27, the tool 25, the ground engaging products 3B, 15 (e.g. bucket and wear members), the human proximity device 50, computing system 198 and/or the handheld device 28 are each optionally in communication through the communication network 40. Examples of communication network 40 include intranets, internets, the Internet, local area networks, wide area networks (WAN), mining site network, wireless networks (e.g. WAP), secured custom connection, wired networks, virtual networks, software defined networks, data center buses and backplanes, or any other type of network, combination of network, or variation thereof. Communication network 40 is representative of any network or collection of networks (physical or virtual) and may include various elements, such as switches, routers, fiber, wiring, wireless, and cabling to connect the various elements of the system 39. Communication between system 39 components and other computing systems, may occur over a communication network 40 or networks and in accordance with various communication protocols, combinations of protocols, or variations thereof. The aforementioned communication networks and protocols are well known and need not be discussed at length here. It should be appreciated that the network 40 is merely exemplary of a number of possible configurations according to embodiments of the present technology. In other examples, the various components of system 39 may be co-located or may be distributed geographically.

As shown in FIG. 7, monitoring tool 25 may include a mobile device 36, a communication device 35, a sensor 31, and a maneuverable arm 29. The tool 25 is remote (i.e., separate) from the earth working equipment 1B and is preferably movable through the mobile device 36. While tool 25 could be tethered to the earth working equipment 1B, the tool 25 would still be considered remote or separate from the equipment because the tool would still be separately movable independently of the equipment to the limits of the tether. Keeping the tool 25 remote or separate from the earth working equipment 1B protects the tool from vibrations and impact shocks associated with the earth working equipment. The mobile device 36 allows the tool 25 the ability to move which allows the tool 25 to, e.g., improve its ability to monitor the ground-engaging products, and/or monitor more than one product or earth working equipment at a time. Using a mobile device separate from the earth working equipment can also minimize or eliminate the need to modify or attach components to the equipment.

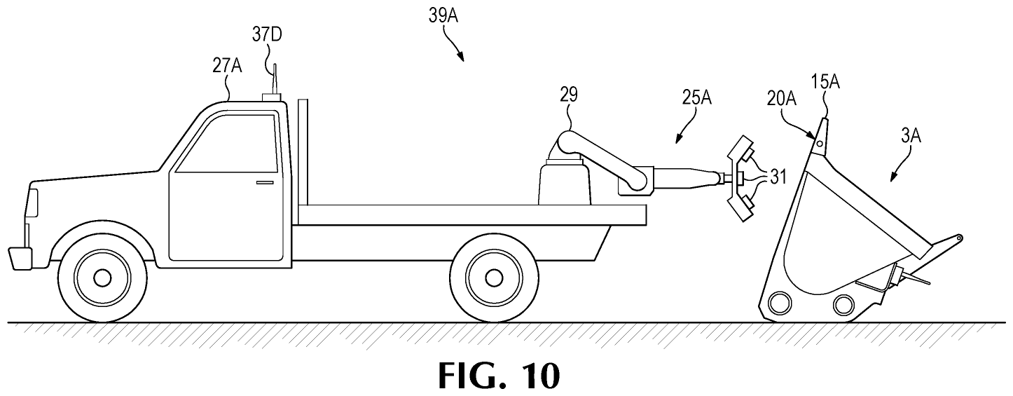

In one example, the mobile device 36 is a UAV 20 in the form of, e.g., a drone, helicopter, blimp, airplane, or other aerial vehicle. In another example, the mobile device 36 is in the form of a service truck mounted robot or ROV (FIG. 10). In another example, the mobile device 36 may be part of an apparatus to perform a different function such as disclosed in U.S. Publication No. 20190360180, which is incorporated by reference herein. Using the mobile device 36, such as a UAV, ground based mobile robot, ROV, service vehicle 27 or handheld device 38 for determining information about the product is advantageous in that the tool 25 can provide unique and varied vantage points. As the mobile device 36 can be positioned accordingly to monitor, an advantage is that the earth working machine requires no down time to monitor the ground engaging products. The use of a tool 25 with a mobile device 36 can also enable the taking of readings at different points during a digging cycle without inhibiting the digging operation or endangering personnel. The use of a mobile tool 25 can permit a sensor 31 to closely approach the areas of interest (such as the products) for secure and reliable gathering of information. Certain embodiments, such as non-manned tools (e.g., UAV, ROV, etc.) may permit safe monitoring while the earth working equipment is in use. Use of a mobile tool 25 also permits a coordinated and efficient monitoring of multiple products (e.g., teeth, shrouds, buckets, etc.), different portions of products (e.g. back or under side), and/or the monitoring of more than one earth working equipment (e.g., other digging machines, haul trucks, conveying equipment, crushers, etc.).

There are a number of off-the-shelf UAVs that can be modified for use as the monitoring tool of the present embodiment. For example, a UAV 20 may require an operator to maneuver the UAV 20 by means of a joystick. The UAV may be controlled manually, autonomously or a combination of control by operator and by programming for flight, takeoff, and/or landing. In addition, the UAV 20 may automatically hover in place above the earth working equipment. In another example, the UAV 20 may not require an operator for takeoff or landing and may fly a set pattern before landing. The UAV 20 may coordinate so as not to land in the same place or location as where the UAV 20 took off.

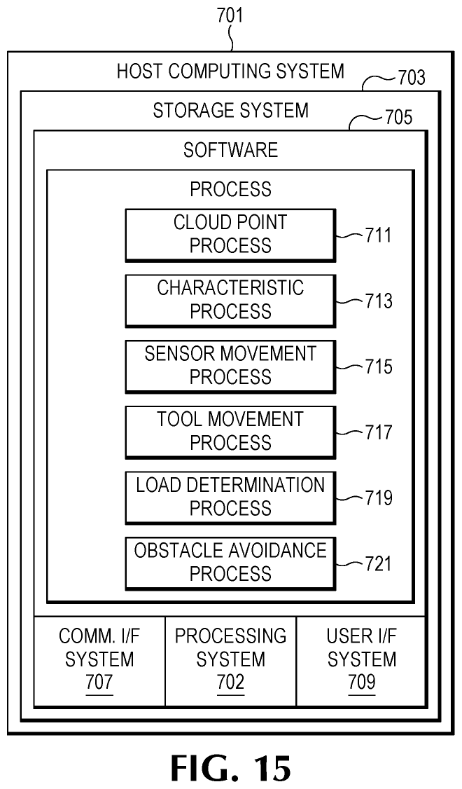

The tool 25 may communicate with one or more remote devices including, e.g., a computing system 198. The computing system 198 may have a processor 199 and memory 200 having computer instructions written thereon. The computing system 198 may include various components that, as an example, are discussed below (FIG. 15). The computing system 198 may include a single computer and/or multiple computers and/or processors at a single location or varied locations with such computers and/or processors working cooperatively or independently. The various components of the computing system 198 may be co-located, virtually, and/or may be distributed geographically. The computing system may be provided to and/or combined with data from other remote devices such as handheld device 28, cloud database 194, other data sources, etc. to provide information and analysis.

In one implementation, the computing system 198 may include the Engine Controller Unit (ECU) for excavating machine 1B. The ECU may provide data to system 39 pertaining to, but not limited to, engine torque, fuel consumption, atmospheric temperature, engine temperature and the like. The ECU data may be coupled with sensor data from tool 25, bucket 3B, tips 15B, and/or data from other sources, and processed by the computing system 198 to provide various outputs.

Tool 25 could optionally include a computer, microprocessor, etc. as a part of computing system 198. Tool 25 could also optionally store data from sensor(s) 31, which could be wirelessly communicated continually, periodically, in batches or the like, or could be retrieved after an operation. Each or any of the system's various components may also optionally include individual processors and/or memory, which may form part of the computing system 198. In one example, the computing system 198 may facilitate communications between the tool 25, various system components, (e.g. equipment 1B, bucket 3B, tips 15B, service truck 27, etc.) and/or other remote devices through the network 40 by means of the communication devices 35 or by other known means. As those skilled in the art will appreciate, other exemplary computing systems 198 according to embodiments of the technology may include different components than those illustrated and described herein.

The computing system 198 (whether part of the tool 25 and/or remote) may include instructions to control one or more sensor 31. The sensor(s) 31 is physically coupled with and or/installed on the mobile device 36 of the monitoring tool 25 and may be configured to detect or monitor or capture a characteristic of a ground-engaging product. The sensor(s) 31 can work in conjunction with other sensors separate from the tool 25. In one example, the sensor 31 on the mobile device 36 could be a passive sensor that collects data and cooperates with an active sensor on the earth moving equipment. As one example, the active sensor of equipment 1B could generate X-rays or polarized light that is reflected off collected ore and collected by the sensor on the tool 25. In another example, the data of sensor 31 can be used with data collected from sensors in other system components, databases, etc.

In the illustrated embodiment (FIG. 7), monitoring tool 25 can monitor the ground-engaging products on the bucket 3B on earth working equipment 1B. As an example, the tool 25 may monitor a point 15 on an adapter 11, a point 15 on an intermediate adapter 13, an intermediate adapter 13 on an adapter 11, an adapter 11 on a digging edge 34, a nose of a cast lip, a shroud 9 on a lip 5, a lip 5 on a bucket 3, the bucket 3, the load in the bucket 24, the earth working equipment 1B supporting the bucket, the digging operation, the earthen bank being excavated, and/or associated equipment such as haul trucks. In other examples, tool 25 may monitor a blade on a mold board, a button or block on a bucket, a wear runner or liner on a bucket, a chute, a bucket, boom and/or stick on earth working equipment, a transfer of material on a chute or conveyer, a truck tray on a haul truck, a tooth on a cutter head, a pick on a drum, wear plate affixed to bucket, a bucket on a boom, a hopper on a crusher, or other ground-engaging products on other kinds of earth working equipment, other kinds of earth working equipment and/or other kinds of operations. In other examples, tool 25 can monitor operations of earth working equipment such as digging efficiency, optimal digging paths, throughputs, etc. In another example, the data gathered by tool 25 can be used by computing system 198 to direct and/or control the actions of the earth working equipment. For example, output could be provided to equipment operators to assist in the control of the operation, assessed for determinations on efficiency, production and the like, etc. In another example, the data can be used by the systems controlling autonomous earth working equipment. In other examples, tool 25 can monitor the ground, such as mineral properties, fragmentation, dig face or work bench topology, etc. Certain implementations of the present disclosure pertain to monitoring characteristics such as the presence, part identification, operational limits, equipment faults, equipment proximity violations, locate system sensors, usage, performance and/or condition, presence and/or identification of cracks, presence and/or identification of deformation of a ground-engaging product associated with earth working equipment.

In another example, the sensor 31 can be used to generate data usable to map a mine site or other earth working site to estimate characteristics of the ground-engaging products on earth working equipment used at the site and/or the worksite. For example, the gathered data could be used to generate contour-style mapping of such things as mineral content, fragmentation, hardness, abrasiveness, wear rates for ground-engaging products, etc. Such mapping can provide more efficient digging, maintenance, etc. As one example, such mapping can lead to better determinations of product replacement schedules, costs, etc. In another example, the data gathered by tool 25 could be combined with other data such as mine geology, GPS data, fragmentation, etc. The data could be used to map other characteristics or process the site data in ways other than mapping to generate similar information. The system 39 data may be coupled with sensor data, and/or data from other sources, and processed by the computing system 198 to provide various outputs.

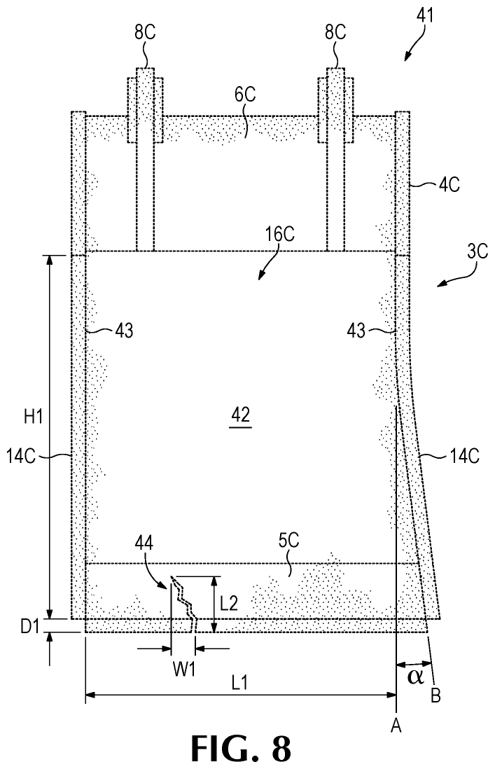

The sensor 31 may be a surface or sub-surface characterization device that generates a two or three-dimensional representation (FIG. 8). The surface characterization device 31 creates or generates the two- or three-dimensional representation of at least a portion of the monitored product, other representations of the product or product surface being monitored. For example, a three-dimensional representation may be generated from more than one two-dimensional optical image captured by a camera 31. In another example, the three-dimensional representation may only be the bit portion 19 or bottom surface of a point 15B or other wear part for wear and/or separation. The monitoring device 25 can include multiple surface characterization devices 31 that collect different kinds of information from a location. As an example, the monitoring tool can collect surface characteristics of a target location in the infrared, visible and/or ultraviolet wavelengths. The collected information can be integrated together to be compared to information stored in a database to identify the surface composition of the location. The tool 25 can collect hyperspectral images that are used to characterize the material of the target (e.g., to determine mineral content in the ground). Ground penetrating radar can be used to collect critical components and/or attributes below the surface.

The sensor 31 may be, for example, a camera, a LiDAR device, a 3D device, a photogrammetry device, and/or a combination thereof. In one example, a camera 31 may be the supported by the tool 25 (or may be in addition to another surface characterization device) and may be directed to capture, e.g., a 2D or 3D profile, and in some cases an image, of at least a portion of the ground-engaging product continuously, at set times or event-based (e.g., upon receiving a trigger or issuance of the alert). The information gathered by tool 25 can be provided to and/or from computing system 198 and/or one or more other remote devices for processing or use, continuously, periodically, on demand, or in batches. Irrespective of the delivery mode, the system can be operated to provide historical and/or real-time data and/or assessments.

Examples of numerous photogrammetry devices, digital cameras, and/or digital single lens reflex (DSLR) cameras could be used to photogrammetrically generate a three dimensional or other representation of the monitored product and/or load. For example, Canon has a digital camera sold under the name EOS 5D, Nikon has a digital camera sold under the name D700, Leica Geosystems has a digital camera sold under the name RCD30, DOT Product LLC has a tablet based structured light camera sold under the name DPI-7, Structure Sensor and ISense have tablet based digital cameras, and Heuristic Lab has a smart phone digital camera under the name LazeeEye that could be used to photogrammetrically generate, e.g., a wear profile of the monitored product. The various cameras 31 could be integrated with the mobile device 36 such as a UAV, ground based mobile robot, ROV, a service truck 27, a handheld device 28, etc. The cameras can generate a two- or three-dimensional profile and/or other information. The data from the cameras could, e.g., be outputted to a database 194 and/or computing system 198 for further processing, which in one example could include generation of a profile.

Examples of LiDAR devices that may be used to generate a two- or three-dimensional point cloud or other representation of a product (e.g., a produce surface(s)) and/or load is a LiDAR device sold by Neptec Technologies Corporation under the name OPAL, and/or a LiDAR device sold by Leica Geosystems under the name Leica Pegasus: Two. The Zebedee and ZEB1 LiDAR devices are designed to be a handheld device 28 but could be integrated with a UAV or other mobile device to generate the representation of the monitored product and/or load. Information generated by the LiDAR device could be output to a database and/or computing system for further processing as will be further discussed below.

Examples of a 3D laser device that may be used to generate, e.g., a two or three dimensional point cloud (or other representation) of the monitored product, product surface(s) and/or load is a laser device sold by Creaform under the name Go!SCAN and a laser device sold by RIEGL under the name VUX-1. Like cameras and/or LiDAR devices, laser devices can be designed as a handheld device 28, integrated with a service vehicle (e.g., a wheeled and/or tracked transport vehicle 27), UAV 20, a ground based mobile robot, ROV or other mobile device 36.

Once the surface characterization (e.g., point cloud 41) is generated, a computing system 198 may analyze the surface of the product. In the illustrated example, the side walls 14C, the rear wall 12C, and the lip 5 of the shell 4C may be monitored for deformation. Deformation, for example, may be determined by the measuring a distance L1 along an entire height H1 of an interior surface 42 of the sidewalls 14C. The cavity 16C defines an interior 42 of the bucket 3C, and the measurement of distance L1 may be taken along the outer edge 43 of the sidewalls 14C, as well as, any point along the interior 42. As a three-dimensional representation 41, it may be that only a portion of the sidewall 14C is deformed and not the entire wall 14C, edge 43, or interior 42. If the distance L1 shows a discrepancy against a previous measurement, a deformation may be detected. As an example, the amount of deformation may be determined by the difference in the discrepancy. In another example, deformation may be measured by overlaying the previous representation of the bucket onto the new representation 41 and measuring the differences. The previous representation may be a previous measurement and/or may be a saved representation of a factory new part as a means for comparison. The deformation may be measured from any iteration of the representations measured including a non-measured saved representation. Such saved representations may be stored in a memory such as database 194. In another example, an angle α may be created from the past angle measurement along a straight-line A and a straight-line B created by the angled or deformed wall 14C. The angle α may be based on an average deviation, the greatest measured of many points, and/or a best fit representation along, e.g., the interior surface 42. Once the angle α reaches a predetermined value (e.g. between 1 and 5 degrees, preferably 3 degrees), or a predetermined value is reached in regard to other deformation monitoring processes, an alert may be issued to repair the bucket 3C. Regardless of the embodiment, the tool 25, computing system 198 and/or other components of system 39 may wirelessly provide alerts to the operator of the earth working equipment, maintenance personnel, mine site managers, suppliers or others. An alert may also be issued prior to reaching the predetermined value, such that an issue may be more specifically monitored. Monitoring tool 25 may include, e.g., other sensors such as an accelerometer, a digital inclinometer unit, a digital compass, an RFID, etc. that may, e.g., assist in monitoring the position of the mobile device 36.

The monitoring tool 25 may be used to detect cracks and/or other damage to the equipment and/or products. The sensors 31 could be of various kinds (e.g., cameras, LiDAR, laser devices, X-ray devices, etc.). In one example, cloud point representation 41 can also show a crack 44. The crack 44 has a measurable distance L2 (e.g. 1 cm) along a longest path of the crack 44. The length could be also be determined as a straight line from one end to the other, as its linear distance along the centerline of the crack or in other ways. A crack 44 may also be measured by a width W1 measurement. The width may be determined at points along the length, as an average, as the greatest or in other ways. A crack 44 may also have a depth D1 (e.g. 1 mm) that can be measured by the monitoring device 25. As with length and width, depth may be determined as an average, the greatest depth, etc. An earth working equipment may also have multiple fractures along a single path or multiple paths, each becoming another crack 44 to be measured and/or assessed. The length, width and/or depth can be used to determine the size and/or severity of the crack. For example, once any one of the measured values W1, L2, D1 has reached a predetermined value (e.g. W1=2 inches, L2=5 inches, D1=0.25 inch), then an alert may be issued. Also, as an example, the crack 44 may be monitored as to its growth by overlaying a previous cloud point presentation over the new cloud point representation 41 to measure the difference in width W1, length L2, and/or depth D1. As with the deformation detection, an alert may be issued at the onset of the crack 44 rather than the measured values width W1, length L2, depth D1 reaching a predetermined value.

Referring back to the tool 25 of FIG. 7, the tool 25 may include a maneuvering device 29 (e.g., an articulated, controlled arm, driven universal joint, etc.) for maneuvering at least one sensor 31. The maneuvering arm 29 may be securely connected to the mobile device 36 at one end 45 and to the sensor 31 at the opposed end 46. In certain examples, the maneuvering device 29 is mounted, so that it has a clear line of sight to monitor the products, equipment, etc. The computing system 198 (on and/or remote from mobile device) may include instructions to control the orientation of the maneuvering device 29. Maneuvering device 29 could, e.g., be a controlled, articulated arm, swivel or other maneuvering implement.

The tool 25 may have a communication device 35 for communicating through the network 40 (or otherwise) to computing system 198 and/or various components of the system 39 that are remote to the tool 25. The communicating device 35 on tool 25 is configured for receiving and/or transmitting information and/or data to and/or from an electronic sensor 31 and/or a remote device such as handheld device 28, transport device 27, database 194 and/or computing system 198, as well as optionally with sensors in other system components such as the equipment, bucket, teeth, shrouds, etc.

The tool 25, databases 194, handheld devices 28, computing system 198, equipment 1B, ground-engaging products 15, etc. may each, some or all include a communication device 35 such as a transceiver for wireless communication. Various components of system 39 may also include a beacon 37 which transmits location information and/or other signal such that location information could be determined, e.g., by signal strength. GPS may alternatively or additionally be used. Multiple antennas 35 could be used to increase the reliability of picking up the signal if desired or needed for the particular operation. Multiple antennas and/or remote devices could be used to increase the reliability of picking up the signal if wireless transmission is used and the additions are desired or needed for the particular operation. The tool 25 can be configured to collect data from characteristics such as cracks, deformation, presence, part identification, presence, operational limits, equipment faults, equipment proximity violations, locate system sensors, condition, usage, performance, wear, etc. The tool 25 may also communicate with other communication devices 35 wirelessly, or through a wired connection which specific product(s) may need maintenance either because the product part is lost, a crack has reached a predetermined value, a deformation has reached a predetermined value, or because the product is worn past the minimum wear profile. In addition, the tool 25 may optionally store the results from the process. System information may be transmitted in various ways, e.g., by electromagnetic waves that can have a wavelength greater than the visible spectrum (e.g., infrared, microwave, or Radio Frequency [RF]), but may be in the ultrasonic or x-ray spectrum, Bluetooth, etc.

The monitoring device 25 can include an exciter or transmitter 35 to transmit energy to a target or receive energy as a receiver. The transmitted energy can stimulate the material of the target to emit energy characteristic of the target material. For example, x-rays impinging on a repeating structure such as a cubic crystal structure will reflect off the molecular structure and can characterize the structure and the material. The polarization of light reflecting off a material can provide information as to the material structure as well.

A transceiver 35 may be, for example, an electromagnetic wave receiver and/or transmitter, a laser receiver and/or transmitter, or Global Positioning System (GPS) and therefore be a location beacon. A ground engaging product such as a bucket or a tooth can be configured with a communication module 35, such as a Bluetooth Low Energy module that stores information such as a serial number, install date or manufacturing date for the component. The tool 25 can poll nearby Bluetooth modules and collect the stored data from any or all modules within polling range. For example, the tool 25 passing within range of an inventory tub or container. This way the tool 25 does not need line of sight with the inventory but can just pass or fly by the inventory tub.

Information regarding ore characteristics can be stored, e.g., in the database 194, the monitoring tool 25, computing system 198 and/or a remote device. Data collected by the monitoring tool 25 can be compared to stored ore characteristics to determine composition of collected earthen materials. Ore characteristics at different wavelengths can be stored in the database. For instance, ore characteristics related to reflected light polarization and ultraviolet reflection can be stored separately. An airborne or other mobile tool 25 can carry separate sensors 31 such as a first sensor to collect surface characteristics of collected ore as to polarization and a second sensor to collect data on ultraviolet light. The collected data can be compared to the stored data to characterize the composition and/or concentration of mined or unmined ore. The airborne device could carry more than two sensors.

With reference to FIG. 7, system 39 may include a human proximity device 50 capable of monitoring the location of a human 51, e.g., within a zone by the earth working area and/or the tool 25. For example, the device may be geofenced within the earth working area and attached to standard human working equipment, such as a hard hat, workman boots, vests, and or other clothing of the like. The human proximity device 50 may be separate or built within the standard human working equipment. The human proximity device 50 may include a beacon 37F, sensor 38, etc. that detects the human proximity device's location, and in turn the human 51 wearing the human proximity device 50. The monitoring tool can use this information to stay a prescribed distance away from the human proximity devices and/or include avoidance software to prevent making contact with a human who is present in or enters the vicinity of the equipment and/or product to be monitored. This allows for a safer work site as people may be performing other maintenance, repair and/or monitoring functions related or unrelated to the functions of the monitoring tool. The tool 25 may also rely on vision recognition software to avoid people near the tool and/or the earth working equipment.

When mobile device 36 is a UAV 20, a transport vehicle 27 with tool 25 may, as an example, be driven to or near (e.g., within a five-mile radius or less) the earth working equipment 1B by an operator located within the transport vehicle 27 but could be driven remotely or autonomously. The tool 25 may be maneuvered directly by an operator, remotely by an operator via a user input on the handheld device 28 or the like, or autonomously. As examples, the tool 25 may be maneuvered with a joystick and cameras and/or sensors located on the tool 25. In an alternative example, the monitoring tool 25 may be flown or fly to locations for monitoring the earth working equipment without the need for a separate transport vehicle 27 to move the tool 25 from location to location.

In an alternative example, the tool 25 may be controlled by a handheld device 28. In some example examples, the handheld device 28 may be configured to maintain a flight pattern determined at least in part on a physical location of the product 15. An operator may physically hold the handheld device 28 as the tool 25 monitors the product (FIG. 7). The handheld device 28 may be a headset for augmented or virtual reality. The handheld device 28 could alternatively be mounted on a stationary or adjustable support. The handheld device 28 may be, for example, a computer, a phone, a tablet, joystick, or other small device that can be held and/or carried by an operator 2. The handheld device 28 may include a sensor 31 (e.g., a camera). The handheld device 28 may be a wireless device, may be integrated with a display system currently in the excavating equipment (e.g., with the OEM display), may be integrated with a new display system within the excavating equipment, and/or may be located in a remote location. The handheld device 28 could be in, e.g., the cab of the earth working equipment, a service vehicle, a station, an office, etc. The handheld device 28 could further include a computing system 198 with a processor 199 and/or combined with data from the tool 25, cloud database 194, other data sources, other remote device, etc. to provide information and analysis.

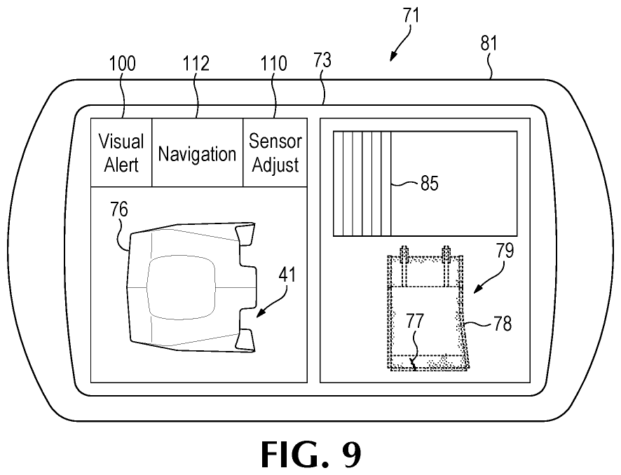

In one example, with reference to FIG. 9, the sensor 31, and/or associated hardware or software may be configured to generate, e.g., a 2D or 3D profile of the product and/or capture and pass characteristic data via a wireless signal from antenna 35 to the handheld device 28 included with, or coupled with, a human machine interface (HMI) 71. The handheld device 28 may include a processor to process the data from and to the various data sources, and data consumers. The data may be transmitted and received by a communication device 35 connected with the handheld device 28. The handheld device 28 may be configured to receive the data relating to wear profile, crack measurements, deformation measurements and generate a profile from the received data.

The handheld device 28 includes a display 73. The display 73 may show earth engaging products, such as wear parts 76, in the form of teeth, fixed to a bucket or otherwise. The display may show a wear parts 76 and points of interest 77, 78, such as cracks and/or deformation locations as described above. The HMI 71 may display the three-dimensional representation, 3D profile, and/or photographic or video graphic image 41 in real time or from memory. The generated profile may be, e.g., compared with existing 2D or 3D profiles retrieved from memory 200, such as the database 198. The result of the comparison may trigger a notification to the handheld device 28, which may be embodied as an alert 100. The HMI 71 may, for example, provide visual alerts (e.g., text and/or pictorial images), haptic feedback (e.g., vibrations), and audio alerts regarding the status of each product. The visual alert may be, for example, a graphical picture 73 displaying each monitored product and the status of each product (e.g., absent/present, acceptable wear, damage, needing maintenance, and reduction in productivity). Other and/or additional, alerts may be used.

The display 73 of the HMI 71 may also include a sensor adjustment interface 110 and/or navigation interface 112. The UAV navigation interface 112 that may include programmable logic, software, or application to control the UAV 20. Programmable logic stored in memory to control the UAV 20 may also, or instead be located on the UAV 20. Movement of the UAV 20 may be determined, e.g., according to GPS coordinates, a datum established at the earth working operation, a datum established on the product, a datum established on the earth working equipment, a datum established at a calculated point adjacent to the earth working equipment, etc. The sensor adjustment interface 110 may be configured to allow for manual adjustment of, for example, sensor 31 position, camera angle, UAV position, UAV height, camera or sensor setting, etc.

In another example, the HMI 71 may be designed to display a live image 79 of the product so that an operator can visually check that an alert is valid. The HMI 71 may be configured to provide a graphical display 73 of the current status of the product 76. For example, a display 73 may be configured to display, e.g., a profile of the monitored product 76, and/or image captured by the sensor 31 (e.g. camera). The image may be a live video feed. The display may be configured to display both still images and video images. The profile 79, or image may be captured from a vantage point determined relative to the product not primarily dependent of the operator manipulation of the excavating machine controls. The display 73 may also display a graphical representation 76 indicative of, for example, a level of wear. The graphical representation may be or include text and/or a numeric value and/or a condition, e.g. “broken tooth”, and like. In this way an operator, or other worker at or associated with the worksite, may be made aware of a potential problem, or characteristic of the product via the alert 100 and may be able to confirm, or discount the condition, and/or provide a value judgement as to the severity of the condition. In this way unnecessary downtime may be avoided. The graphical representation 76 may be or include information related to ore composition and/or concentration.

In another example, the HMI 71 may be designed to display a history chart 85 so that an operator can determine when an alert happened so that an operator can take the necessary actions if a product is lost. In this way the operator is able to make better informed decisions regarding the product(s) 76. The display 73, and/or a similarly configured display may also be available to other personnel at, associated with, or remote to the worksite.

FIG. 10 illustrates a tool 25A where the mobile device is a service vehicle 27A. FIG. 10 illustrates another example of a system 39A in accordance with the disclosure. The tool 25A may include a maneuvering device 29A (e.g., an articulated, controlled arm, driven universal joint, etc.) for maneuvering at least one sensor 31A. in the illustrated example, a mobile device 27A supports the sensor 31A, such that the tool 31A can be maneuvered to point and/or location without an additional mobile device. In certain embodiments, the maneuvering device 29 is mounted on a transport vehicle 27A capable of maneuvering a sensor 31 so that it has a line of sight to monitor, e.g., the products 15A. The sensor 31A may be a surface characterization device, e.g., a camera or other device that creates, e.g., a two- or three-dimensional representation (e.g. point cloud) of at least a portion of the product, (e.g. underside) or other representation of the product 15A or product surface being monitored. The electronic sensor 31A may be used in cooperation or including with a tool 26A for removing and/or installing products. While the bucket 3A is shown unattached to earth working equipment, tool 25A could be used with the bucket secured to the equipment.

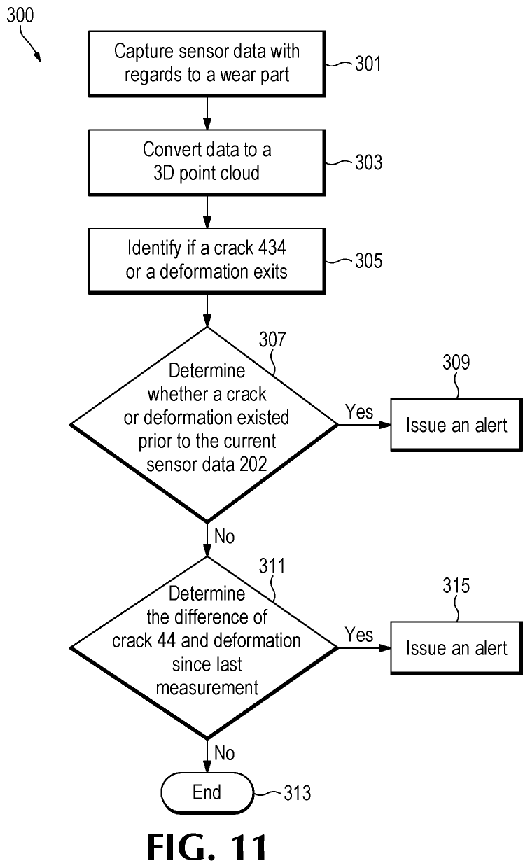

FIG. 11 is a process or program 300 for determining the presence and/or monitoring of a crack and/or deformation according to one example of the disclosure. Process 300 may be implemented in program instructions in the context of any of the software applications, modules, components, or other such programming elements deployed in a computing system 198. The program instructions direct the underlying physical or virtual computing system or systems to operate as follows, referring parenthetically to the steps in FIG. 11.

To begin, a given monitoring tool 25 captures sensor data 202 with regards to, e.g., a wear part 76 (Step 301). The data 202 captured may be captured in form and then converted to a 3D point cloud or may be captured as a point cloud representation 41 (Step 303). The data 202 may be transmitted to a computing system 198 remote from the monitoring tool 25 or a computing system 198 on the monitoring tool 25. If transmitted or otherwise, the program 300 identifies if a crack 44 and/or a deformation (e.g., angle α) exists (Step 305). Deformation, for example, may be determined by in a variety of different including those described above.

Next, the program determines whether a crack or deformation existed prior to the current data 202 (Step 307). If a crack and/or deformation never existed, then issue an alert (Step 309). In this case, an alert is issued prior to reaching the predetermined value, such that an issue may be more specifically monitored. If a crack and/or deformation previously existed, then determine the difference of crack 44 and deformation since last measurement (Step 311). For example, the crack 44 has a measurable distance L2 along a longest path of the crack 44. A crack 44 may also be measured by a width W1 measurement. A crack 44 may also have a depth D1 that can be measured by the monitoring device 25. The measured values W1, L2, D1 should be measured against a predetermined value (e.g. W1=2 inches, L2=5 inches, D1=0.25 inch). In another example, the crack 44 may be monitored as to its growth by overlaying a previous cloud point presentation over the new cloud point representation 41 to measure the difference in width W1, length L2, and depth D1.

If the difference of the crack or deformation is the same as previous, then end (Step 313). Otherwise, if deformation (angle α) or crack 44 has increased to reach a predetermined value (e.g. 3 degrees), then issue an alert (Step 315).

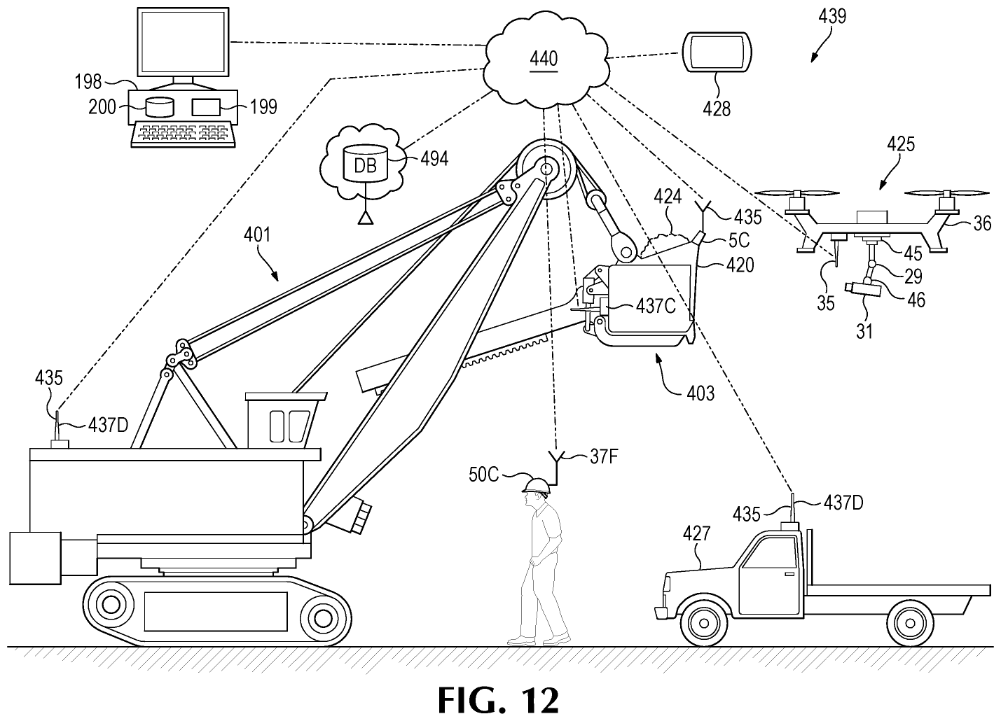

FIG. 12 illustrates another example of a system 439 in accordance with the disclosure. In system 439, the tool 425 flies or is brought to the earth working equipment 401 with a product 415 to be monitored. Depending on the type of electronic sensor 431 that is used it may be necessary for a monitoring tool 425 to come into close proximity (e.g. 30 ft. or less, preferably between 1 ft. and 5 ft.) with an earth working equipment 401.

If the tool 425 has a sensor 431 that requires the tool 25 to be in close proximity to the earth working equipment 401 the tool 425 may communicate with the transport device 427, handheld device 428, database 494, and/or other remote devices 437A, 437B, 437C, 437D, 437F to aid a tool's obstacle avoidance system. As one example, if any of the transport device 427, handheld device 428, database 494, and/or other remote devices includes a GPS sensor (e.g., located on the bucket 403), the tool 425 may have programmable logic that calculates a protected zone for the obstacle avoidance system (based on the known geometry and/or orientation of the bucket and the known geometry and/or orientation of the excavating equipment) so that the tool 425 may enter the protected zone even when the bucket 403 is actively moving. For example, the tool 25 can move into a position along the calculated path that allows the tool 25 to capture the desired position and/or orientation (e.g. underside) of the ground engaging product(s). In another implementation, the tool 25 may move to a position along the calculated path that allows the tool 25 to capture a desired position or orientation of the ground-engaging product based on the predicted behavior of the excavating equipment and/or ground-engaging product. A safety radius for human proximity devices 50 may be necessary and calculated into the determined path prior to the monitoring device entering the safe pathway. The safety radius may allot for the randomness of movement of humans in comparison to the repetitive nature of the earth working equipment and the various other components of system 439. Likewise, tool 25 may include an avoidance system to avoid contact with the earth working equipment.

In another example, the tool 425 may receive position information from the earth working equipment that may aid in helping the tool 425 move (e.g., fly) close to, e.g., the bucket 403 when the earth working equipment 401 is and/or is not in use. This may be helpful to determine, e.g., the condition and/or wear profile of a tip 15, an intermediate adapter 13, an adapter 11, shroud 9, and/or lip 5. Using a mobile device 36 such as a UAV 20 may permit the sensor to detect hard to monitor surfaces including, e.g., the bottom surfaces of the various wear parts.

The computing system 498 may use programmable logic for the tool 425 or system 439 to process information (e.g. photos of bottom side 420 to create a 3D profile) from the at least one sensor 431 and may also use the information from one or more of the remote sensors, database 494, handheld device 428, transport device 427, and/or computing system 498 to determine characteristics of the product 415. The programmable logic can, e.g., provide an estimated wear life remaining for the product 415 or a portion of a product (e.g. backside 420) and provides an estimate on the likelihood that the product 415 will be lost, damaged, or lead to a reduction in productivity or damage to the earth working equipment. The programmable logic can also, e.g., provide an alert that the product 415 is acceptable for continued use or that the product 415 should be replaced.

In another example, impacts are monitored, and programmable logic can determine unexpected or out of predetermined limit activity that should be investigated. For example, a majority of the impacts are only to one side from a specific direction. Predictive modelling, machine learning, or both can indicate that such impacts can potentially damage the ground engaging product and where that damage may occur. The tool 425 can be dispatched by an alert created in the programming to focus on the predicted area where the damage may be located from the impact data. The tool 425 may dispatched at the behest of the operator or through artificial intelligence.

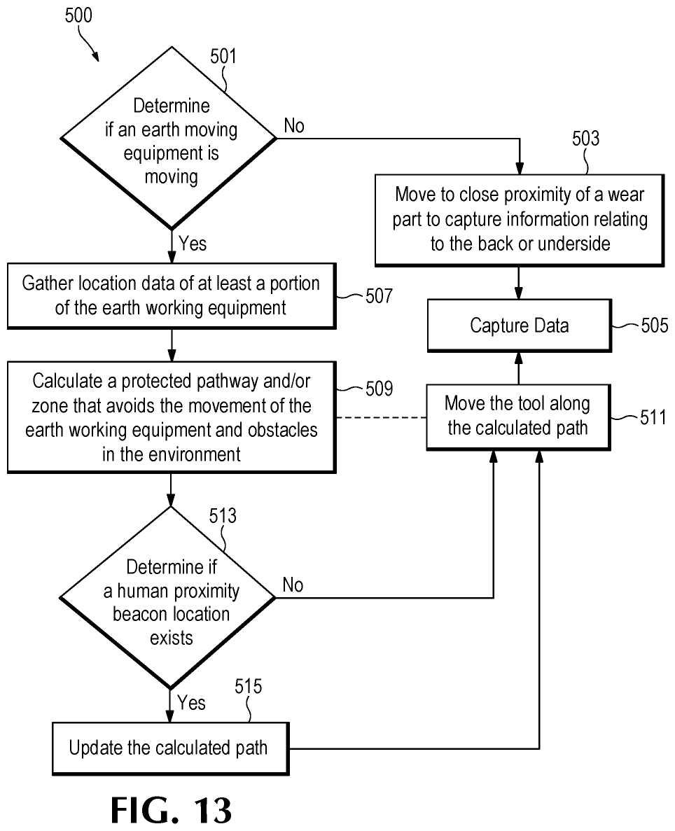

As one example, FIG. 13 is a method or process or program 500 for determining the wear of an underside of a wear part or ground engaging product according to one example of the disclosure. The information gathered may be used in determining wear life or may be used with other information (e.g. other sides of the wear part) to create a wear profile of the entire wear part. Process 500 may be implemented in program instructions in the context of any of the software applications, modules, components, or other such programming elements deployed in a computing system 198. The program instructions direct the underlying physical or virtual computing system or systems to operate as follows, referring parenthetically to the steps in FIG. 13.

To begin, a given monitoring tool 25 determines if an earth moving equipment 1 is moving (Step 501). If not, then the tool 25 may determine if there are any human proximity beacons 50 and/or other machine beacons are within a predetermined distance. If none exist and/or the earth moving equipment is not moving, then the tool 25 moves to close proximity of a wear part 76 attached to an earth working equipment to capture information relating to the back or underside of the wear part 76 (Step 503). From this position, the data is captured (Step 505). Data may be presented in real time or saved to memory for further analysis. Such information may include for an earth moving equipment having a bucket, the condition and/or wear profile of the bottom surface 26 of a tip 15, the bottom surface of a shroud 9, the bottom surface 30 of a base 13, the bottom surface of the adapter 11, and/or the bottom surface 33 of the lip 5. The wear profile may be a 2D profile or 3D profile and may be used to compare with known wear profiles stored in database 494 or other memory. The data 202 captured may be captured in form and then converted to a 3D point cloud or 3D profile or may be captured as a point cloud representation 41 initially. The data 202 may be transmitted to a computing system 198 remote from the monitoring tool 25 or a computing system 198 on the monitoring toll 25.

If the earth working equipment is moving, then the tool 25 will gather location data of the earth working equipment or at least a moving portion thereof (Step 507). The location data could be obtained from other information gathering devices in the area, on the earth working machine, on wear components of the earth working machine, or from the tool 25 itself. In one example, the information gathering devices may be any of the transport device 27, handheld device 28, database 194, or other remote device that may include a location sensor, such as a GPS sensor to aid in determining the location of an earth working equipment or wear product 76, e.g., the bucket 3. This step may also include gathering location data for a location of the ground engaging product or portion thereof that is to be specifically monitored. The mobile device 36 may have been alerted or tagged to monitor a specific location on the ground engaging product.

Next, the tool 25 or computing system 198 may have programmable logic that calculates a protected zone and/or path for the obstacle avoidance system around obstacles in the environment (Step 509). In one example, the programmable logic device may utilize the remote devices based on the repetitive nature of the earth working equipment and the known geometry and/or orientation of the bucket; the known geometry and/or orientation and/or predicted orientation of the excavating equipment, transportation vehicle, and handheld device, so that the tool 25 may enter the protected zone even when the bucket 3 is moved. In another example, tool 25 and/or computing system 198 may receive signals pertaining to the operation of the earth working equipment from transmitters associated with the machine. In this way, the tool 25 can time patterned intervals on when the ground-engaging product will be oriented a predetermined way (e.g. oriented upwards so that the underside is visible). Once the path is calculated, the tool 25 may move along the path to close proximity (Step 511) and capture the data (Step 505). For example, the tool 25 can move into position along the calculated path to capture the desired orientation based on the predicted behavior.

The programmable logic takes into account the location of the human proximity device(s) 50 as illustrated in FIG. 13 so the tool 25 may review or determine the locations of human proximity devices 50 (Step 513). If no beacons 50 are within a predetermined distance of the determined protected zone, then the tool will move into protected zone (Step 511) and capture data (Step 505). If there are human proximity beacons within the calculated protected zone, then the programmable logic will need to recalculate or update the protected pathway to avoid the human proximity beacons 50 (Step 515). Certain safety rules, such as a safe radius for the human proximity devices 50 may be included into the calculation of the protected zone and/or path. It is understood that the protected zone may have to change on the fly depending upon the movement of the obstacles (e.g. remote devices). A precautionary radius may be predetermined for each of the obstacles (e.g., remote devices) or may be set as a single unique value (e.g. 5 ft. radius). In one implementation, the monitoring tool 25 may have to abandon the calculated protected zone or path due to the erratic nature of the remote devices. In this case, the monitoring tool 25 may wait a predetermined amount of time (e.g. 1 min) before calculating a second protected zone. The behavior of the human and therefore the human proximity device 50 may be erratic, so the checking of beacons 50 may be done even during the movement into the protected zone.

The tool 425 and/or computing system 498 may use programmable logic for the tool 425 or system 439 to process the information (e.g. photos of bottom side 420 to create a 3D profile) from the at least one sensor 431 and may also use the information from the remote sensors, database 494, handheld device 428, transport device 427, and/or computing system 498 to determine characteristics of the product 415 (Step 505). The programmable logic can, e.g., provide an estimated wear life remaining for the product 415 or a portion of a product (e.g. backside 420) and provides an estimate on the likelihood that the product 415 will be lost, damaged, or lead to a reduction in productivity or damage to the earth working equipment. The programmable logic can also, e.g., provide an alert that the product 415 is acceptable for continued use or that the product 415 should be replaced.

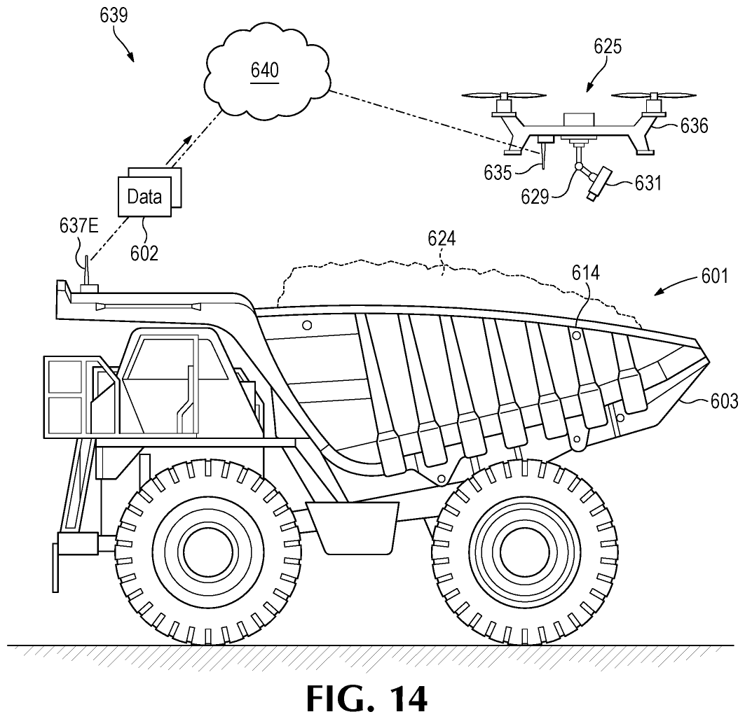

FIG. 14 illustrates another example of a system 639 for monitoring a truck tray 603 of a loading truck 601 for load, cracks, and/or deformation according to one example of the disclosure. The system 639 may include a loading or dump truck 601 having a truck tray 603, a communication network 40, and a monitoring tool or monitoring system or monitoring device 625. The truck 601 is similarly referenced to the earth working equipment 1B of FIGS. 1A and 7 and earth working equipment 1 of FIG. 1. The truck 603 having a remote device, a beacon 637E, and/or some combination. The truck 601 includes a truck tray 603. The truck tray 603 may be carrying a load 624 (shown in phantom). The truck tray 603 may further include runners and other wear parts. The truck 603, the remote device on the truck tray, and the tool 25 are each in communication through the communication network 640. The tool 625 is positioned separate from (e.g., flies above) the loading truck 603 and generates, e.g., three-dimensional profiles using at least one electronic sensor 631.

In one example, a monitoring tool 625 can provide data for a real-time assessment of characteristics of an operation. The sensor 631 may generate a two or three-dimensional point cloud representing an outer surface of a truck tray 603 being monitored. Once the point cloud is generated, deformation, for example, may be determined by the measuring a distances and angles of sidewalls 614C and/or comparing to previous measurements as explained above. Once an angle of deformation reaches a predetermined value (e.g. 3 degrees), then an alert may be issued to repair the truck tray 603.

In one example, the 2D or 3D representation can be gained as a point cloud representation of, in this example, the truck tray 603, but other ways of monitoring the system are possible. In this example, cracks, for example may be identified and monitored by measuring distances, widths, and depths and/or comparing to previous measurements as explained above. As with the deformation detection, an alert may be issued at the onset of the crack in the truck tray 603.

In one alternative, the tool 625 may monitor the load 624 within the truck 601 (e.g., on a truck bed 603) without interrupting the operation of the loading truck 601. Monitoring the load 624 of the truck 601 allows the operators of the earth working equipment to know, e.g., when they have reached a full evenly distributed load, so that the operator does not under or over load the truck 601 and potentially damage the products or other components of the earth working equipment. It is also important that the operator does not continually under load the earth working equipment so that production is sub-optimal.

In addition, a monitoring tool 625 can capture positions of the machine, boom, stick, bucket, and bank during the digging cycle. One alternative version includes the concurrent monitoring of both the load in a bucket and the load in a hopper or the truck tray 603 receiving the material from the bucket and/or the characteristics of the bucket and/or truck tray 603. For example, the sensor 631 can generate data on its own or in combination with data 602 from a database or remote device 637E to determine the load within, e.g., a bucket or truck body 603. The system 639 may generate a two or three-dimensional profile of the load 624 within a bucket or truck tray 603.

In another alternative, the tool 625 can monitor the load gathered in a bucket and in the truck tray 603 being filled to provide information to the operator on more efficiently filling the truck tray 603. This information may be utilized for helping optimize/validate product design and for optimizing/validating product performance for the customer. As an example of efficiency, the system may indicate the awaiting haul truck will be completely filled with the bucket being only partially (e.g., half) filled. In this way, the system can increase the efficiency and production of the operation. Real-time assessments can be used in other ways such as to optimize the digging path, schedule maintenance, estimate production, operator performance (e.g. filling rate, digging cycle time, overstressing time period, load cycle time, material loss rate), etc.

In another example, a processor on the tool 625, computing system, remote devices, a handheld, and/or a mobile device may be equipped to process the information from the at least one sensor 631 and may additionally use the information from the remote devices, the handheld, the mobile device, and/or a database to determine, e.g., the number of times the earth working equipment has been filled, the average time it takes to fill the earth working equipment, the fill rate of the earth working equipment, the volume within the earth working equipment, and/or the effectiveness of the loading process. In one alternative, the system may use density and/or volume data from tool 625 and load data from the haul truck hydraulic cylinders to determine the load 624 carried by the haul truck 603.

The tool 625 may also use a program, computer instructions, or programmable logic for the processor to determine the number of loads, the cycle time between loads, the fill rate of the earth working equipment, and/or the effectiveness of the loading of the earth working equipment. The tool 625 may also provide data that is subject to real-time processing to assist, e.g., in evenly distributing and full loading of a truck tray 603. For example, the system 639 may provide information to the operator on the load to gather (e.g., half a bucket) to completely fill the awaiting haul truck 603.

The tool 625 may use programmable logic to determine the amount of earthen material within the earth working equipment based on, e.g., a two or three-dimensional profile of the load 624. The tool 625 may also determine an estimated weight of the load 624 within the truck 601 based on volume (determined, e.g., from the profile), the degree of fragmentation of the material (e.g. through excavation or through crushing), and/or the material type. The tool 625 may also verify the estimated weight of the load 624 by comparing the estimated weight to the stated weight from a load monitoring unit installed on the earth working equipment. The degree of fragmentation of the material may be determined by the tool 625 or may be determined by a device 637E remote to the tool 625. The type of material or material concentration being excavated may be determined by the tool 625, a device 637E, or the tool 625 may reference a database with the information.

FIG. 15 is a schematic system diagram illustrating an example machine representing the systemization of the computing system 701 used to monitor in accordance with the various examples described above. Examples of computing system 701 include, but are not limited to, server computers, web servers, cloud computing platforms, and data center equipment, as well as any other type of physical or virtual server machine, container, and any variation or combination thereof. Computing system 701 may be implemented as a single apparatus, system, or device or may be implemented in a distributed manner as multiple apparatuses, systems, or devices. Information and/or data received from the can be processed by processing system 702, which could be part of the tool, the earth working equipment, handheld device, mobile device, computing system, and/or remote device(s). Computing system 701 includes, but is not limited to, processing system 702, storage system 703, software 705, communication interface system 707, and user interface system 709 (optional). Processing system 702 is operatively coupled with storage system 703, communication interface system 707, and user interface system 709.

Computing system 701 may employ central processing units (CPUs) or processors to process information. Processing system 702 may be implemented within a single processing device but may also be distributed across multiple processing devices or sub-systems that cooperate in executing program instructions. Examples of processing system 702 include programmable general-purpose central processing units, special-purpose microprocessors, programmable controllers, graphical processing units, embedded components, application specific processors, and programmable logic devices, as well as any other type of processing device, combinations, or variations thereof. Processing system 702 may facilitate communication between co-processor devices. The processing system 702 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. In one implementation, the processing system 702 or other elements of the system 701, may be operatively coupled with or be an Equipment Control Unit (ECU). In another implementation, processing system 702 may expedite encryption and decryption of requests or data.

A processing system 702 may comprise a micro-processor and other circuitry that retrieves and executes computer instructions, programs, applications, and/or software 705 from storage system 703. Processing system 702 executes program components in response to user and/or system-generated requests. One or more of these program components may be implemented in software, hardware or both hardware and software 705. Processing system 702 may pass instructions (e.g., operational and data instructions) to enable various operations.

Communication interface system 707 may include communication connections and devices that allow for communication with other computing systems over communication networks. For example, communication interface system 707 may be in communication with a network 40.

Examples of connections and devices that together allow for inter-system communication may include network interface cards, antennas, power amplifiers, RF circuitry, transceivers, and other communication circuitry. Communication interface system 707 may use various wired and wireless connection protocols such as, direct connect, Ethernet, wireless connection such as IEEE 802.11a-x, miracast and the like. The connections and devices may communicate over communication media to exchange communications with other computing systems or networks of systems, such as metal, glass, air, or any other suitable communication media. The aforementioned media, connections, and devices are well known and need not be discussed at length here.

The communication interface system 707 can include a firewall which can, in some implementations, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. Other network security functions performed or included in the functions of the firewall, can be, for example, but are not limited to, intrusion-prevention, intrusion detection, next-generation firewall, personal firewall, etc., without deviating from the novel art of this disclosure.

User interface system 709 facilitate communication between user input devices, peripheral devices, and/or the like and components of computing system 701 using protocols such as those for handling audio, data, video interface, wireless transceivers, or the like (e.g., Bluetooth®, IEEE 1394a-b, serial, universal serial bus (USB), Digital Visual Interface (DVI), 802.11a/b/g/n/x, cellular, etc.).

User input devices may include card readers, finger print readers, joysticks, keyboards, microphones, mouse, remote controls, retina readers, touch screens, sensors, and/or the like. Peripheral devices may include antenna, audio devices (e.g., microphone, speakers, etc.), cameras, external processors, displays, communication devices, radio frequency identifiers (RFIDs), scanners, printers, storage devices, transceivers, and/or the like. As an example, the user interface 709 may receive data and format data to be displayed on a display.

User input devices and peripheral devices may be connected to the user interface 709 and potentially other interfaces, buses and/or components. Further, user input devices, peripheral devices, co-processor devices, and the like, may be connected through the user interface system 709 to a system bus. The system bus may be connected to a number of interface adapters such as the processing system 702, the user interface system 709, the communication interface system 707, the storage system 705, and the like.

Storage devices 1390 may employ any number of magnetic disk drive, an optical drive, solid state memory devices and other storage media. Storage system 703 may include volatile and nonvolatile, removable and non-removable media implemented in any method or technology for storage of information, such as computer readable instructions, data structures, program modules, or other data. Examples of storage media include tangible, non-transitory storage devices or systems such as fixed or removable random access memory (RAM), read only memory (ROM), magnetic disks, optical disks, flash memory, virtual memory and non-virtual memory, magnetic cassettes, magnetic tape, solid state memory devices, magnetic disk storage or other magnetic storage devices, or any other suitable processor-readable storage media. In no case is the computer readable storage media a propagated signal. The storage system 703 may employ various forms of memory including on-chip CPU memory (e.g., registers), RAM, ROM, and storage devices. Storage system 703 may be in communication with a number of storage devices such as, storage devices, databases, removable disc devices, and the like. The storage system 703 may use various connection protocols such as Serial Advanced Technology Attachment (SATA), IEEE 1394, Ethernet, Fiber, Universal Serial Bus (USB), and the like.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

The storage system may be a database 194 or database components that can store programs executed by the processor to process the stored data. The database components may be implemented in the form of a database 194 that is relational, scalable and secure. Examples of such database 194 include DB2, MySQL, Oracle, Sybase, and the like. Alternatively, the database 194 may be implemented using various standard data-structures, such as an array, hash, list, stack, structured text file (e.g., XML), table, and/or the like. Such data-structures may be stored in memory and/or in structured files.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. Computer-executable instructions stored in the memory may include an interactive human machine interface or platform having one or more program modules such as routines, programs, objects, components, data structures, and so on that perform particular tasks or implement particular abstract data types. For example, the memory may contain operating system (OS), modules, processes, and other components, database tables, and the like. These modules/components may be stored and accessed from the storage devices, including from external storage devices accessible through an interface bus.

Software 705 (including cloud point process 711, characteristic process 713, sensor movement process 715, tool movement process 717, load determination process 719, and obstacle avoidance process 721) may be implemented in program instructions and among other functions may, when executed by processing system 702, direct processing system 702 to operate as described with respect to the various operational scenarios, sequences, and processes illustrated herein. For example, software 705 may include program instructions for implementing a redirect process to redirect packet traffic as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to provide packet redirection. Indeed, encoding software 705 on storage system 703 may transform the physical structure of storage system 703. For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

The cloud point process 711 is used to process the information generated from the electronic sensor 31 that, e.g., captures data and is converted to a two- or three-dimensional profile of the product and/or the load being monitored or captures the two- or three-dimensional profile initially as data. The cloud point process 711 may receive data from a sensor or other device to generate a cloud point representation. Depending on what type of sensor 31 is being used to generate, e.g., the profile, the programmable logic may be software sold by Autodesk under the name RECAP, software sold by PhotoModeler under the name PhotoModeler Scanner, software sold by Acute 3D under the name Smart3DCapture, software sold by Agisoft under the name PhotoScan, software sold by Trimble under the name Business Center, software by CloudCompare, software by MeshLab, software by LAStools, software by itSeez3D and/or various software known for processing three dimensional point cloud data.

The cloud point process 711 may add the representation of product to the wear profile database. In other examples, a separate process may be used to add representations to the wear profile database. The previously or established wear profile may be a CAD model or other profile of a new product or may be a previously recorded profiles of the product. The previously established wear profile may be stored in storage system 703, such as a database, on the transport device 27, on the tool 25, or on the remote devices. In this way the wear profile database is able to be populated with a variety of wear profiles for a variety of products used on a variety of earth working equipment regardless of the manufacturer. The cloud point process 711 may be used on the monitoring device and/or the remote devices in the form of, e.g., a computing system 701 that is remote to and/or within the monitoring tool 25.

In addition to the cloud point process 711, e.g., three dimensional point cloud representation, the characteristic process 713 may determine such things as the concentration of material, type or composition of material, crack identification, identity of the product, the presence or absence of the product, the current wear profile, the estimated wear life remaining, identifying the risk of loss, deformation identification, and/or providing alerts to the operator. The characteristic process 713 may, e.g., be able to compare the current wear profile or current risk indicators to a previously established wear profile, risk indicators and/or bit portion lengths in a database to determine the estimated wear life remaining, whether the product has separated from the earth working equipment, or to identify the risk that the product may become lost or damaged in the near future.

The characteristic process 713 may also compare the current wear profile (e.g. of a bottom or under side) against a database containing the minimum bottom side wear profile for the product. Based on the known minimum wear profile, the current wear profile, and/or previously established wear profiles of the product, the characteristic process 713 can determine the remaining life of the product. Likewise, the characteristic process 713 may compare previous established cracks or deformations against the current representation to better establish life of the product (e.g. through measurements such as angle α, L1, D1, W1, L2) as discussed above.

In addition to the data related to the wear profiles of the product or ore profiles, the characteristic process 713 may receive information related to, e.g., how long the product has been in use, how many digging cycles the product has encountered, and or the mine geology to predict the remaining wear life of the product. The characteristic process 713 may provide an estimated remaining wear life as a unit of time, remaining units of material moved, or as a unit of digging cycles. The characteristic process 713 may produce a precautionary alert that a specific product is close to needing replacement. The alert may be, for example, a visual alert, haptic feedback, and/or an audio alert. In addition, the characteristic process 713 may produce an alert if the profile indicates that the product has been lost or if the product has been worn so that it is equal to or less than the recommended minimum wear profile. In addition, the characteristic process 713 may provide an indication of current flaws or predictions of future flaws that may lead to loss, damage, or failure of the product that may lead to a reduction in productivity and/or equipment downtime.

The sensor movement process 715 may allow for maneuvering at least one sensor or sensor 31. This may be accomplished by the user interface 709 by means of a graphic user interface (GUI) or a human machine interface (HMI), touch screen, or another peripheral device. The sensor movement process 715 may have computer logic to orient a maneuvering device 29 (e.g., an articulated, controlled arm, driven universal joint, etc.) with the intent of getting a clear view of the ground engaging product or wear product or bottom or underside of the wear product. Maneuvering device 29 could be a controlled to move in any direction allowed by the mechanics of the device, such as up, down, side to side, roll, zoom, swivel or other maneuvering direction.

The tool movement process 717 may autonomous fly the UAV 20 above earth working equipment. In another example, the tool movement process 717 may allow the UAV 20 to be manipulated. This may be accomplished by the user interface 709 by means of a graphic user interface (GUI) or a human machine interface (HMI), touch screen, or another peripheral device. The tool movement process 717 may allow for autonomous takeoff or landing and may fly a set pattern before landing at or near the same location as takeoff. The tool movement process 717 may coordinate autonomously so as not to land in the same place or location as where the UAV 20 took off. In an alternative example, the tool movement process 717 may be control the UAV 20 autonomously to fly to new locations for monitoring the earth working equipment without the need for a separate transport vehicle 27 to move the tool 25 from location to location. The tool movement process 717 may recognize that an earth working equipment is down and that the ground engaging product is oriented a particular way (e.g. in a way to provide a clear line of sight to a bottom or under side) and will fly to that earth working equipment.

The load determination process 719 may monitor the amount of material in a ground-engaging product, e.g., a bucket or truck tray. In one example, the load determination process 719 can determine the amount of collected material by generating, e.g., a two- or three-dimensional profile of the load, either using the cloud point process 711 or having processes similar to. As examples, the load determination process 719 may provide an approximate weight of the load based on such things as mine geology, the degree of fragmentation of the material, and/or the volume of the material within the earth working equipment. In other examples, the load determination process 719 may receive information from a remote device on the earth working equipment, e.g., to validate the weight of the load within the earth working equipment.

In an alternative, the load determination process 719 may generate, e.g., a two or three dimensional profile of a load in, e.g., a bucket or truck tray, determine the amount of gathered material, store the results, repeat the process to historically track the loads, analyze the historical data to determine such things as the fill rate of the earth working products, the cycle time between loads, the number of fill cycles, and/or the earth working equipment's effectiveness and/or production.

The obstacle avoidance process 721 may be utilized when a surface of a ground engaging product is obstructed from view from a sensor or tool. This becomes more complicated when the earth working equipment housing the ground engaging tool is moving. The obstacle avoidance process 721 will gather information from other information gathering devices in the area to determine orientation of ground engaging products and earth moving equipment. Those information gathering devices may be any of the transport device 27, handheld device 28, database 194, and/or remote device, that may include a location sensor, such as a GPS sensor to aid in determining the location of an earth working equipment or wear product 76, e.g., the bucket 3.

The obstacle avoidance process 721 may calculate a protected zone and/or pathway to travel for the tool to move around the earth working equipment and ground engaging products. The calculation is based on the known geometry and/or orientation and/or pattern of the ground engaging product and the known geometry and/or orientation and/or predicted pattern or orientation of the earth working equipment. The obstacle avoidance process 721 will maneuver the tool 25 to enter the protected zone or pathway to take a measurement (e.g. wear, bottom side surface, crack, etc.).

As will be appreciated by one skilled in the art, examples of the present invention may be embodied as a system, method or computer program product. Accordingly, examples of the present invention may take the form of an entirely hardware embodiment, an entirely software embodiment (including firmware, resident software, micro-code, etc.) or an embodiment combining software and hardware implementations that may all generally be referred to herein as a “circuit,” “module” or “system.” Furthermore, implementations of the present invention may take the form of a computer program product embodied in one or more computer readable medium(s) having computer readable program code embodied thereon.

Although the above discussion has discussed the disclosure primarily in connection with a load within a bucket and teeth on a bucket, the tool can be used to create, e.g., a two or three dimensional profile of other products or product surface(s) on a bucket such as shrouds, wings, and/or runners or other earth working equipment attachments and components. Moreover, systems of the present disclosure can also be used to monitor the presence and or condition of products on other types of earth working equipment such as runners on chutes, pikes on crushers, pipes, valves, truck trays, or end bits on blades.

The above disclosure describes specific examples for a tool for monitoring characteristics such as crack identification and measurement, deformation identification and measuring, measurements for wear on a bottom side of a wear part of an earth working equipment and the status of ground-engaging products on earth working equipment. The system includes may include different implementations or features of the disclosure. The features in one example can be used with features of another example. The examples given and the combination of features disclosed are not intended to be limiting in the sense that they must be used together.

1. A monitoring system comprising:
an earth working equipment; and
a monitoring tool including a mobile device movable to different remote positions relative to the earth working equipment, and a sensor on the mobile device to detect a crack on at least one monitored portion of the earth working equipment.

2. The monitoring system of claim 1 including a programmable logic device to receive and analyze data collected by the sensor on one such crack on the earth working equipment, and provide an output pertaining to the crack.

3. The monitoring system of claim 2 wherein the output includes information on a length and/or width of the crack.

4. The monitoring system of claim 2 wherein the output includes information on a depth of the crack.

5. The monitoring system of claim 2 wherein the output includes a determination on the severity of the crack.

6. A monitoring system comprising:
an earth working equipment; and
a monitoring tool including a mobile device movable to different remote positions relative to the earth working equipment, and a sensor on the mobile device to detect a deformation of at least one monitored portion of the earth working equipment.

7. The monitoring system of claim 6 including a programmable logic device to receive and analyze data collected by the sensor on one such deformation on the earth working equipment, and provide an output pertaining to the deformation.

8. The monitoring system of claim 7 wherein the output includes a determination on the severity of the deformation.

9. The monitoring system of claim 2 wherein the output includes a determination on whether the at least one monitored portion of the earth working equipment should be repaired and/or replaced.

10. The monitoring system of claim 2 wherein the output includes an estimate of when the at least one monitored portion will need to be repaired and/or replaced.

11. The monitoring system of claim 1 wherein the at least one monitored portion of the earth working equipment includes a working base.

12. The monitoring system of claim 11 wherein the working base includes a bucket, cutter head and/or rotating drum.

13. The monitoring system of claim 11 wherein the at least one monitored portion includes a ground-engaging wear part secured to the working base.

14. The monitoring system of claim 13 wherein the working base includes a digging edge and the ground-engaging wear part is secured to the digging edge.

15. The monitoring system of claim 1 wherein the at least one monitored portion of the earth working equipment includes a ground-engaging wear part.

16. The monitoring system of claim 1 wherein the at least one monitored portion includes a component of a tooth and/or a shroud secured to the earth working equipment.

17. The monitoring system of claim 1 wherein the earth working equipment includes an excavating machine and a bucket having walls to define a cavity into which earthen material is gathered, a lip, and supports for securing the bucket to the excavating machine, and wherein the at least one monitored portion includes the walls, lip and/or supports.

18. The monitoring system of claim 17 wherein at least one monitored portion includes wear parts secured to the lip.

19. The monitoring system of claim 1 wherein the at least one monitored portion includes a boom and/or a stick of the earth working equipment.

20. The monitoring system of claim 1 wherein the earth working equipment includes an excavating equipment.

21. The monitoring system of claim 1 wherein the earth working equipment includes a conveying equipment.

22. The monitoring system of claim 21 wherein the conveying equipment includes a haul truck with a truck tray, and the at least one monitored portion includes the truck tray.

23. The monitoring system of claim 1 wherein at least one monitored portion includes a chute and/or a conveyor.

24. The monitoring system of claim 1 wherein the earth working equipment includes a mineral processing equipment.

25. The monitoring system of claim 1 wherein the at least one monitored portion includes a hopper.

26. The monitoring system of claim 1 wherein the monitoring tool includes a communication device to wirelessly transmit data collected by the sensor on one such crack on the earth working equipment.

27. The monitoring system of claim 1 wherein the sensor creates a point cloud representation of the at least one monitored portion of the product.

28-42. (canceled)

43. A monitoring tool comprising a mobile device movable to different remote positions relative to an earth working equipment, and a sensor on the mobile device to detect a crack on at least one monitored portion of the earth working equipment.

44. The monitoring tool of claim 43 wherein the sensor detects a length and/or width of the crack.

45. The monitoring tool of claim 43 wherein the sensor detects a depth of the crack.

46. The monitoring tool of claim 43 wherein the monitoring tool includes a communication device to wirelessly transmit data collected by the sensor on one such crack on the earth working equipment to a remote device.

47. A monitoring tool comprising a mobile device movable to different remote positions relative to an earth working equipment, and a sensor on the mobile device to detect a deformation of at least one monitored portion of the earth working equipment.

48. The monitoring tool of claim 43 wherein the sensor includes a surface characterization device.

49. The monitoring tool of claim 43 wherein the sensor includes an optical camera.

50. The monitoring tool of claim 43 wherein the sensor creates a point cloud representation of the at least one monitored portion of the product.

51-54. (canceled)
